(19) United States
(12) Patent Application Publication
(10) Pub. No.: US 2026/0001411 A1
(43) Pub. Date: Jan. 1, 2026

(54) METHOD FOR COORDINATING ELECTRIC DRIVE SYSTEM FOR AGRICULTURAL TRACTOR

(71) Applicant: DEERE & COMPANY, MOLINE, IL (US)

(72) Inventors: VOLKER KEGEL, MANNHEIM (DE); JULIAN BAUMANN, KARLSRUHE (DE); DOUGLAS B. BECHTHOLD, MOUNT AUBURN, IA (US)

(21) Appl. No.: 19/247,571

(22) Filed: Jun. 24, 2025

(30) Foreign Application Priority Data
Jul. 1, 2024 (EP) 24185745.7

(51) Int. Cl. B60L 15/20; A01B 76/00; B60L 1/00; B60L 50/60

(52) U.S. Cl. CPC B60L 15/20; A01B 76/00; B60L 1/003; B60L 50/60; B60L 2200/40; B60L 2240/12

(57) ABSTRACT

A method for coordinating an electric drive system for an agricultural tractor with an electric traction drive unit, an electric PTO shaft drive unit and a common energy source for supplying energy to the electric traction drive unit and the PTO shaft drive unit is introduced. The electric PTO shaft drive unit is monitored by a control unit, in terms of a power-related drop in PTO shaft speed, in order to adapt a predetermined speed of travel of the agricultural tractor by activating the electric traction drive unit in such a way that a power-related drop in PTO shaft speed is decreased.

### CROSS-REFERENCE TO RELATED APPLICATIONS

This application claims priority to European Patent Application No. 24185745.7, filed Jul. 1, 2024, which is hereby incorporated by reference.

### TECHNICAL FIELD

The present disclosure relates generally to a method for coordinating an electric drive system for an agricultural tractor.

### BACKGROUND

The electrification of vehicle units previously operated by means of an internal combustion engine is also playing an increasing role in the agricultural vehicle sector.

### SUMMARY

According to an aspect of the present disclosure, a method for coordinating an electric drive system for an agricultural tractor with an electric traction drive unit, an electric PTO shaft drive unit, and a common energy source for supplying energy to the electric traction drive unit and the PTO shaft drive unit is introduced. The method comprises monitoring the electric PTO shaft drive unit by a control unit, in terms of a power-related drop in PTO shaft speed to adapt a predetermined speed of travel of the agricultural tractor by activating the electric traction drive unit in such a way that the power-related drop in PTO shaft speed is decreased.

Other features and aspects will become apparent by consideration of the detailed description, claims, and accompanying drawings.

### BRIEF DESCRIPTION OF THE DRAWINGS

The method according to the disclosure will be explained in more detail hereinafter on the basis of the appended drawings. Component parts of equivalent or comparable function are identified by the same reference signs in this case. In the drawings:

FIG. 1 shows an exemplary embodiment, illustrated as a block diagram, of the method according to the disclosure for coordinating an electric drive system for an agricultural tractor.

FIG. 2 shows a schematically illustrated exemplary embodiment of an electric drive system in an agricultural tractor.

Like reference numerals are used to indicate like elements throughout the several figures.

### DETAILED DESCRIPTION

In the case of agricultural tractors, depending on the intended purpose, in addition to a traction drive unit, this also relates in particular to the operation of a PTO shaft situated in the rear or front region of the agricultural tractor. This PTO shaft is set in rotation by means of an independent electric PTO shaft drive unit. In order to supply energy to the electric traction drive unit and the PTO shaft drive unit, a common energy source is generally used which is a chargeable battery, a fuel cell or the like.

If the power requirement of an accessory or supplementary device driven by the PTO shaft or at least one work function performed by the accessory or supplementary device increases, it is possible that the power supplied by the common energy source may be insufficient to meet it completely. Consequently, the PTO shaft speed decreases, which results in corresponding limitations in the at least one work function performed by the accessory or supplementary device.

The object is therefore to ensure an improved supply of energy to an electric PTO shaft drive unit in an agricultural tractor.

This object is achieved by a method for coordinating an electric drive system for an agricultural tractor.

In the method according to the disclosure for coordinating an electric drive system for an agricultural tractor, the electric drive system comprises an electric traction drive unit, an electric PTO shaft drive unit and a common energy source for supplying energy to the electric traction drive unit and the PTO shaft drive unit, wherein the electric PTO shaft drive unit is monitored by a control unit, in terms of a power-related drop in PTO shaft speed, in order to adapt a predetermined speed of travel of the agricultural tractor by activating the electric traction drive unit in such a way that a power-related drop in PTO shaft speed is decreased.

To be more precise, for this purpose a lowering of the power consumption of the electric traction drive unit is effected by a corresponding reduction of the speed of travel of the agricultural tractor such that the common energy source is capable of complying with the increased power requirement of the electric PTO shaft drive unit, which increased power requirement causes the observed drop in PTO shaft speed.

The speed of travel can be specified by preselecting a desired target speed of travel via an associated control element in the form of a motion control lever or the like, wherein the speed of travel is regulated to the preselected target speed of travel by activating the electric traction drive unit. Alternatively, the preselection of the target speed of travel can also be made at a driver assistance system provided in the agricultural tractor, for example a system for tractor/accessories automation.

Advantageous developments of the method according to the disclosure can be found in the one or more embodiments disclosed herein.

The drop in PTO shaft speed is preferably decreased by the control unit by minimizing a difference between a predetermined target PTO shaft speed and a current PTO shaft speed detected by sensors. It is ensured as a result that the predetermined target PTO shaft speed is observed or maintained as precisely as possible. The predetermined target PTO shaft speed typically has fixed values of 540 rpm and 1000 rpm.

It is furthermore possible for the drop in PTO shaft speed to be decreased at the control unit only to the extent that the speed of travel of the agricultural tractor does not fall below a predetermined minimum value. This ensures the maintenance of a continuous traveling movement of the agricultural tractor, and an undesired complete standstill of the agricultural tractor and thus an interruption in the work procedure during the at least one work function performed by the accessory or supplementary device is thus excluded.

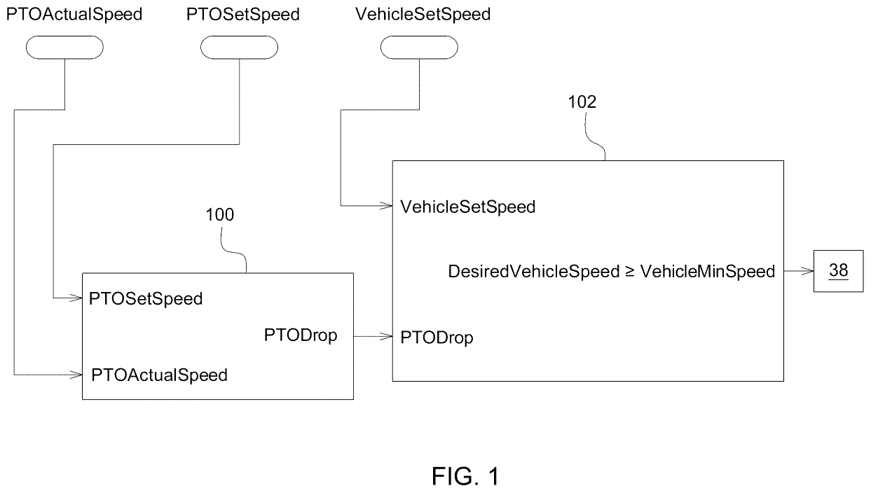

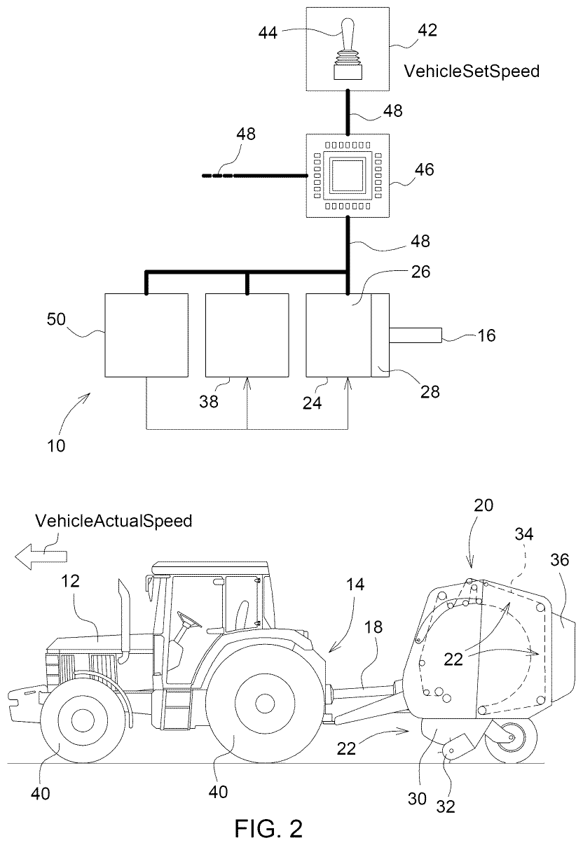

FIG. 1 shows an exemplary embodiment, illustrated as a block diagram, of the method according to the disclosure for coordinating an electric drive system corresponding to FIG. 2.

Starting from FIG. 2, the electric drive system 10 is a constituent of an agricultural tractor 12 with a PTO shaft 16 which is situated in the rear region 14 and to which a cardan shaft 18 of an accessory or supplementary device 20 can be connected in order to drive mechanical assemblies 22, comprised by the accessory or supplementary device 20, which serve to perform associated work functions. The PTO shaft 16 can for this purpose be set in rotation by means of an electric PTO shaft drive unit 24 which for its part has an electric motor 26 and a PTO shaft gearbox 28 connected downstream of the latter. The accessory or supplementary device 20 is, for example, a baler 30, with mechanical assemblies 22 in the form of a crop intake 32 and pressing or discharge devices 34, 36.

An electric traction drive unit 38 is furthermore present, by means of which the agricultural tractor 12 can be set in motion via driven wheels 40 according to a speed of travel VehicleActualSpeed which can be predetermined by the operator. Specification by the operator of the speed of travel VehicleActualSpeed is made by preselecting a desired target speed of travel VehicleSetSpeed via a control element 42 in the form of a motion control lever 44, wherein the speed of travel VehicleActualSpeed is regulated to the preselected target speed of travel VehicleSetSpeed by activating the electric traction drive unit 38 according to a control command DesiredVehicleSpeed generated by a control unit 46 (also see FIG. 1 in this regard). The control element 42 as well as the two drive units 24, 38 are here connected to the control unit 46 via a CAN databus 48. Alternatively, the preselection of the target speed of travel VehicleSetSpeed is made at a driver assistance system (not shown in FIG. 2) provided in the agricultural tractor, for example a system for tractor/accessories automation.

A common energy source 50 is used to supply energy to the electric traction drive unit 38 and the electric PTO shaft drive unit 24. The energy source 50 is a chargeable battery, a fuel cell or the like.

If the power requirement of the accessory or supplementary device 20 driven by the PTO shaft 16 or the work functions performed by the accessory or supplementary device increases, it is possible that the power supplied by the common energy source 50 may be insufficient to meet it completely. Consequently, the PTO shaft speed decreases, which results in corresponding limitations in the work functions performed by the accessory or supplementary device 20.

The method illustrated in FIG. 1 as a block diagram takes this situation into account by means of a target PTO shaft speed PTOSetSpeed predetermined by an operator being compared by the control unit 46 in a first step 100 with a current PTO shaft speed PTOActualSpeed detected by sensors in order to monitor the electric PTO shaft drive unit 24 in terms of a power-related drop in PTO shaft speed PTODrop. Such a situation is inferred by the control unit 46 when the result of the comparison is that the deviation between the predetermined target PTO shaft speed PTOSetSpeed and the current PTO shaft speed PTOActualSpeed has positive values,

PTOSetSpeed−PTOActualSpeed≥0.

If this is the case, in a second step 102 the speed of travel VehicleSetSpeed, predetermined by the operator, of the agricultural tractor 12 is adapted by the control unit 46 by activating the electric traction drive unit 38 or by modifying the control command DesiredVehicleSpeed generated by the control unit 46 in such a way that the power-related drop in PTO shaft speed PTODrop is correspondingly decreased by minimizing the difference between the predetermined target PTO shaft speed PTOSetSpeed and the current target PTO shaft speed PTOActualSpeed,

PTOSetSpeed−PTOActualSpeed→0.

It is ensured as a result that the predetermined target PTO shaft speed PTOSetSpeed is observed or maintained as precisely as possible. The predetermined target PTO shaft speed PTOSetSpeed typically has fixed values of 540 rpm and 1000 rpm.

In other words, a decrease of the power consumption of the electric traction drive unit 38 is effected by a corresponding reduction of the speed of travel VehicleActualSpeed of the agricultural tractor 12 such that the common energy source 50 is capable of complying with the increased power requirement of the electric PTO shaft drive unit 24, which increased power requirement causes the observed drop in PTO shaft speed PTODrop.

It is furthermore provided that the drop in PTO shaft speed PTODrop is decreased at the control unit 46 in the second step 102 only to the extent that the speed of travel of the agricultural tractor 12 does not fall below a predetermined minimum value VehicleMinSpeed. This ensures the maintenance of a continuous traveling movement of the agricultural tractor 12, and an undesired complete standstill of the agricultural tractor 12 and thus an interruption in the work procedure during the work functions performed by the accessory or supplementary device 20 is thus excluded.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A method for coordinating an electric drive system for an agricultural tractor with an electric traction drive unit, an electric PTO shaft drive unit, and a common energy source for supplying energy to the electric traction drive unit and the PTO shaft drive unit, the method comprising:
monitoring the electric PTO shaft drive unit by a control unit, in terms of a power-related drop in PTO shaft speed; and
adapting a predetermined speed of travel of the agricultural tractor by activating the electric traction drive unit in such a way that the power-related drop in PTO shaft speed is decreased.

2. The method of claim 1, wherein the drop in PTO shaft speed is decreased by the control unit by minimizing a difference between a predetermined target PTO shaft speed and a current PTO shaft speed detected by sensors.

3. The method of claim 1, wherein the drop in PTO shaft speed is decreased at the control unit only to the extent that the speed of travel of the agricultural tractor does not fall below a predetermined minimum value.

4. An electric drive system for an agricultural tractor, comprising:
an electric traction drive unit;
an electric PTO shaft drive unit;
a common energy source for supplying energy to the electric traction drive unit and the PTO shaft drive unit;
a control unit configured to monitor the electric PTO shaft drive unit, in terms of a power-related drop in PTO shaft speed, in order to adapt a predetermined speed of travel of the agricultural tractor by activating the electric traction drive unit in such a way that the power-related drop in PTO shaft speed is decreased.

5. The electric drive system of claim 4, wherein the drop in PTO shaft speed is decreased by the control unit by minimizing a difference between a predetermined target PTO shaft speed and a current PTO shaft speed detected by sensors.

6. The electric drive system of claim 4, wherein the drop in PTO shaft speed is decreased at the control unit only to the extent that the speed of travel of the agricultural tractor does not fall below a predetermined minimum value.
